(19) United States
(12) Patent Application Publication
(10) Pub. No.: US 2002/0095833 A1
(43) Pub. Date: Jul. 25, 2002

(54) Flying ghosts movable ornamental display

(76) Inventor: Michael Rutkoske, Gales Ferry, CT (US)

Correspondence Address: Michael Rutkoske, 49 Robin Hood Drive, Gales Ferry, CT, 06335, US

(21) Appl. No.: 09/727,220

(22) Filed: Nov. 30, 2000

(51) Int. Cl. G09F 19/00

(52) U.S. Cl. 40/429

(57) ABSTRACT

An improved method for presenting a display at home, office or buisness incorporating motion with an unlimited number of objects. My invention, consists of continuous loop of line such as monofiliment, twine or string. Attached to this loop are the displayed objects such as ghosts, pumpkins and reindeer from a small length of line. This loop and objects are suspended above the ground by wrapping the loop around at least two support positions. These support positions consist of a pulley attached to a solid object such as a tree, a pole or a house. One of these pulleys is connected to the shaft of a motor such as that from a fan. The remaining pulleys are designed such that the line from the connected object passes freely around the pulley. When operated, the motor turns the pulley which causes the entire loop to move in its path around all of the pulleys in the system. When this happens, the objects move along with the loop giving the appearance of realistic motion.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Decorating the home, office or shopping establishment is commonplace during holidays or other special occasions. People go to extreme lengths to have a display which is better than others. The types of displays which incorporate motion of otherwise inanimate objects is fun and exciting. Even better are those which require thought into how the display works.

Various methods have been used in providing ornate displays which incorporate motion. Ozeki utilizes a central tower which has an arm attached perpendicular to it and is rotated. A flying object is connected to the end of the arm via a string and caused to rotate about the center simulating flight. This method allows only a circular path about a center point. This center point base, support and arm are clearly visible removing perception that the objects are flying without assistance.

Zinbarg has three patents related to apparatus design and setup to emulate a floating ghost. In these patents, the ghost structure is supported by its head to a fixed location thereby maintaining the ghost elevated. The bottom of the ghost is fixed at several places to the ground so that the ghost maintains an angular orientation with the ground. The motion in these patents is due to flapping of the ghost in the wind. While the ghost does have the motions of flying when there is wind, there is no translation of the ghost with respect to the ground which would provide the most realistic display. Also, the Zinbarg design does not pertain to displays which might be used for other occasions within the year.

The patent held by Belokin incorporates a motor which along with its battery pack for power, is suspended by a wire. Attached to the shaft of the motor is another wire to which the displayed object is connected. The rotation of the motor shaft imparts vibrations and rotational motion to the wire causing the object to display a fluttering motion. This method of display is intended for one displayed object located in a small display area with some structure above to support the motor. The purpose for this motor is mainly to impart vibrational motion into the object, not for moving the object along a path. In addition, the motor is clearly visible while looking at the displayed object which eliminates the mysteriousness of the motion.

Canonica presents a display in which marine animals are suspended in a fluid and moved through the fluid utilizing a magnetic coupling means. The drive magnet is connected to a motor in the base of the display while the opposing magnet resides in the fish itself. As the motor moves the drive magnet, the fish moves through the water in an undulating motion. This concept is effective for small confined displays where magnets are close enough to couple. This concept does ot apply in large size and area displays.

Wotton utilizes a clear wrap with facial indicia to wrap around an object such as a tree. While this is effective in providing an illusion that the object may be alive, there is no motion.

While the prior art has included displays which have provided motion to an object, even some in random patterns, none has provided a display which can have large or small travel paths, which incorporates a method for providing the motion which is not easily identified, which can be adapted to provide displays for any occasion, and which provide random motion all in the same design as my invention “Flying Ghosts Movable Ornamental Display” does.

Consequently, is has been desirable to have an improved animated display which presents a more grand, intriguing and fun atmosphere than provided by the aformentioned prior art.

### BRIEF SUMMARY OF INVENTION

This invention is an improved method for presenting a display at home, office or business incorporating motion with an unlimited number of objects. My invention, consists of continuous loop of line such as monofiliment, twine or string. Attached to this loop are the displayed objects such as ghosts, pumpkins and reindeer from a small length of connecting line. This loop and objects are suspended above the ground by wrapping around at least two support positions. These support positions consist of a pulley attached to a solid object such as a tree, a pole or a house. One of these pulleys is connected to the shaft of a small motor such as that from a fan. The remaining pulleys are designed such that the line from the displayed object passes freely around the pulley. When operated, the motor turns its pulley which causes the entire line loop to move in its path around all of the pulleys in the system. When this happens, the individual connecting lines move with the loop. The objects also move since they are attached to the connecting line which are moving with the loop. Since the objects are suspended by a small section of line, movement through the air gives the object a realistic motion. The use of monofiliment or transparent line gives the illusion that the objects are moving unassisted. The speed of the objects may be adjusted by a multi speed motor or pulley size.

This method provides a method which unlike the prior art, is quick and easy to set up, provides realistic motion of the object, and provides the illusion that the object is not connected to anything.

### BRIEF DESCRIPTION OF THE SEVERAL VIEWS OF THE DRAWING

FIG. 1 shows the setup of the flying ghosts with the loop being supported at three positions, 1 motor and 2 pulleys. The motor assembly is shown being attached to the eve of a house. The two other support locations are shown to be in trees. Attached to the loop are three displayed objects, ghosts, which are attached to the loop with a connecting line. Detailed figures of the swivels, motor, idler pulley apparatus, and ghost are shown to be in FIGS. 2, 3, 4, and 5 respectively.

FIG. 2 shows the swivel connector which attaches the loop to the connecting line for the display object. The loop is shown wrapped through the top portion of the swivel while the connecting line is tied to the lower portion of the swivel.

FIG. 3 shows a view of the small motor with the pulley attached to the shaft. This figure shows a set screw attaching the pulley to the motor, however, other methods may be used depending on the motor shaft configuration. Also shown are the mounting brackets and screws to attach the motor to a fixed object such as the eve of a house.

FIG. 4 shows the idler pulley set. This set has a portion which is a screw thread for attaching to a tree, post or other fixed object in a orientation such that the pulley is maintained horizontal and below the screw portion. The pulley is held onto the shaft of the pulley screw using a pin which fits in a hole in the end of the pulley screw.

FIG. 5 shows a ghost, one of the possible displayed objects which can be used in this invention. The ghost consists of a covering over a filler material. The covering is gathered around the filler material and fastened with a twist tie or string to form a ghost head. The connecting line attaches to the top of the head.

### REFERENCE NUMERALS IN FIGURES

| | | | |
|---|---|---|---|
| 10 | Loop | 30 | Displayed Object |
| 12 | Motor | 32 | Eyelet |
| 14 | Drive Pulley | 34 | Central Sphere |
| 16 | Set Screw | 36 | Motor Bracket |
| 18 | Pulley Screw | 38 | Mounting Screw |
| 20 | Idler Pulley | 40 | Motor Shaft |
| 22 | Pin | 42 | Ghost Covering |
| 24 | Swivel | 44 | Filler Material |
| 26 | Fixed Location | 46 | Twist Tie |
| 28 | Connecting Line | 48 | Ghost |

### DETAILED DESCRIPTION OF THE INVENTION

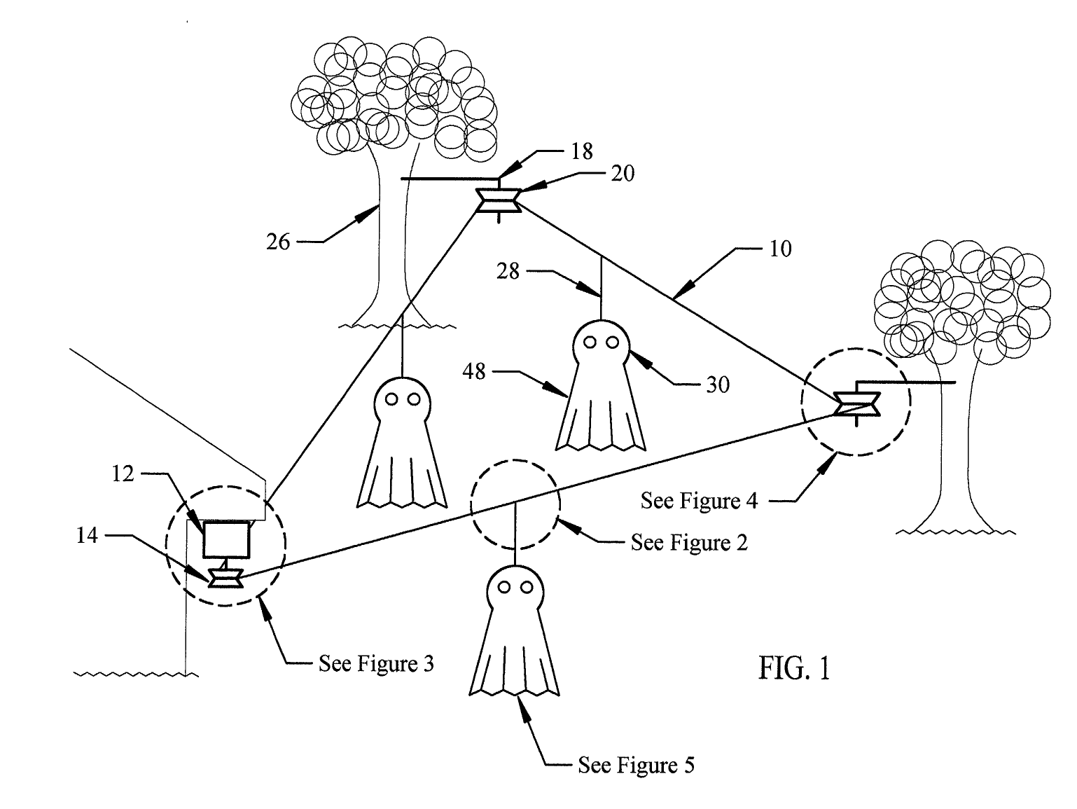

My invention is a method of displaying objects for various purposes in a manner which emparts motion to the object. This motion is in the form of a continuous path which the object follows as seen in FIG. 1.

In order to accomplish this, a continuous loop 10 is formed. This loop 10 may be made from materials such as rope, string, or monofiliment. Attached to this loop 10 in multiple locations is a connecting line 28, typically made from the same material as the loop 10. This connecting line 28 is attached to the loop 10 by either tying a knot in the connecting line 28 surrounding the loop 10 or using a swivel 24 shown in FIG. 2. The swivel 24 is used in applications such as fishing where the lure is allowed to rotate without causing the length of fishing line to be twisted. The swivel 24 consists of a central sphere 34 with eyelets 32 extending above and below the sphere 34 which can rotate with respect to the sphere. The swivel 24 is attached to the loop 10 by pinching a portion of the loop 10 and feeding it through one of the swivel eyelets 32. The pinched loop 20 is passed far enough through the eyelet 32 to allow the swivel 24 to be passed through the loop formed by that portion. The loop 20 is then pulled tight causing the loop 10 to be wrapped about the eyelet 32 as shown in FIG. 2. Use of the swivel 24 for this application allows the displayed object 30 to rotate freely without causing the connecting line 28 to become twisted in the loop 10. The length of the connecting line 28 can vary depending on the desired height of the object 30 or the clearance of obstacles such as shrubs or fences. The longer the connecting line 28, the greater the chance of the displayed object 30 being tangled in another object or caught by a child. The shorter the connecting line 28, the greater the chance of the object becoming caught in one of the pulleys 14,20.

Attached to the end of the connecting line 28 is the displayed object 30. The connecting line 28 is tied to some portion of the displayed object 30, typically in a location which allows the object to appear balanced and to provide a solid connection to support the weight of the object. In some cases, such as using a reindeer as the displayed object 30, there may be two connecting lines 28 to maintain the proper orientation of the reindeer. For this object which does not rotate, the swivel 24 may not be necessary.

The displayed object 30 is connected to the loop 10 via the connecting line 28. This object 30 follows the path of the loop 30. The displayed object 30 is typically something which flies such as a ghost, witch, or reindeer. The displayed object 30 may also be purely ornamental such as flowers, a rabbit or a flag. The displayed object 30 should be of size and weight which the loop 10 can support with minimal droop. The heavier the object 30, the more the loop 10 will droop and possibly cause the loop 10 to come off the pulley 14,20. Some weight is desireable in order to prevent the object 30 from being blown by the wind and wrapping around the loop 10.

One of the possible displayed objects 30 which can be used with this invention is that of a ghost 48. FIG. 1 shows three ghosts 48 in this display each connected to different parts of the loop 10 via the connecting line 28. FIG. 5 shows a detailed view of the makeup of the ghost 48. In order to fabricate this ghost 48, a ghost covering 42 in the form of a fabric or plastic material is placed over some filler material 44. The filler material 44 may be comprised of paper or a balloon. This filler material 44 is used to form the head of the ghost 48 so the amount of filler material 44 required depends on the desired size of the ghost head. The ghost covering 42 is then formed around the filler material 44 and fastened in place using a string or twist tie 46. The connecting line 28 is then tied to the ghost 48 through the ghost covering 42. This connecting line 28 is attached to the loop 10 as described above. Details including a face may be applied to the ghost covering 42 in order to accent the ghost 48.

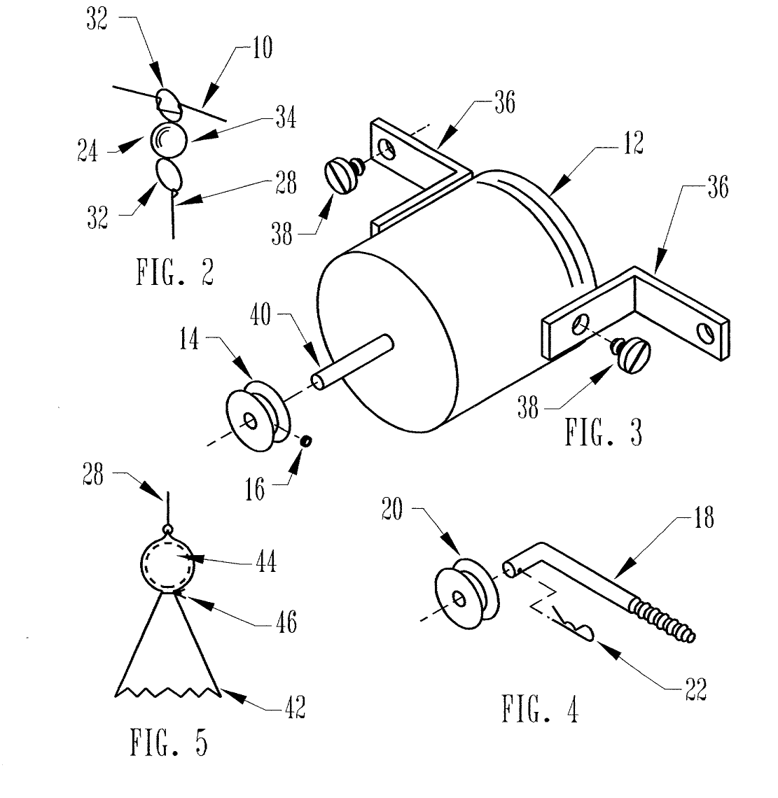

In order to make the displayed object 30 appear to be flying, the loop 10 must move along its path. The path is determined by the positioning of a multitude of pulleys 14,20 around which the loop 10 is routed. The number of pulleys 14,20 may vary depending on the size and route of the loop 10. If only two pulleys 14,20 are used, the displayed objects 30 may pass too close to each other causing the connecting lines 28 from the objects to become tangled. Three is an effective number of pulleys 14,20. These pulleys 14,20 are positioned such that loop 10 engages a large portion of the pulley 14,20 circumference minimizing the possibiltiy of the loop 10 from bouncing off the pulley 14,20. One of the pulleys is a drive pulley 14. This pulley 14 is connected to an electric motor 12 or some other motive force causing the pulley 14 to rotate. The drive pulley 14 is attached to the motor shaft 12 using a set screw 16 or other means as seen in FIG. 3. In order for the pulley 14 to rotate the loop 10, a rubber band or other device may be placed around the pulley 14 to maximize the coefficient of friction between the pulley 14 and the monofiliment loop 10. The other pulleys along the route are idler pulleys 20 which the driven loop 10 rotates about. The idler pulleys 20 are mounted on a pulley screw 18 and are secured with a pin 22 passing through a hole in the pulley screw 18 as shown in FIG. 4. The positioning of the motor 12/ drive pulley 14 assembly and that of the idler pulleys 20 on the pulley screws 18 is such that allows the loop 10 to pass around the entire pathway with no obstructions for the connecting line 28 and the displayed object 30 which are hanging down from the loop 10. All of the pulleys 14,20 are orientated in the horizontal position with the center hole for the pulley 14,20 being vertical. The motor 12/ drive pulley 14 assembly may be fastened to a fixed location 26 such as the eave of a house using mounting brackets 36 and mounting screws 38. This provides stability for the driver pulley 14 and protects the motor 12 from the weather. The idler pulley 20 assemblies may be attached to any fixed location 26 such as a house, pole, or tree in such a way that the pulley 20 is horizontal and the pin 22 which holds the pulley 20 on the pulley screw 18 is below the pulley 20.

The loop 10 is positioned around the driver 14 and idler pulleys 20 in the pathway. The tension of the loop 10 should be such as to support the weight of all the displayed objects 30 with minimal droop of the loop 10 while not overstressing the loop 10 and causing the motor shaft 12 and idler pulleys 20 to bind.

When started, the motor 12 turns the drive pulley 14 which is attached to it. This rotating drive pulley 14 moves the loop 10 in a path around the idler pulleys 20 at the other fixed locations 26. As the loop 10 is forced to move about its idler pulleys 20, the connecting line 28 and displayed objects 30 are also caused to move. The speed of the loop 10 and objects 30 may be altered by using a variable speed motor 12 or changing the size of the drive pulley 14 connected to the motor 12.

Constructing this system in the above fashion creates the display of objects 30 moving about the fixed locations 26. Being that the loop 10 and connecting line 28 are small, they are not very noticeable. In addition, the length of the connecting line 28 allows the object 30 to acheive random motions while they are dragged through the air. The final display is that of the objects 30 moving seemingly by themselves with natural motions. All will be intrigued by the display wondering how did you do that.

What I claim as my invention is:

1. A moving display system comprising:
a. a closed loop
b. a plurality of guide means around which said loop is routed,
c. a means for moving said loop around said guide means,
d. a desired number of displayed objects,
e. a means for connecting said displayed objects to said loop,
f a means for supporting said guide means and said loop with said displayed objects attached in a desired configuration where the displayed object is free to pass around said guide means.

2. The moving display system of claim 1 wherein said loop is made of materials including monofiliment line, twine or rope.

3. The moving display system of claim 1 wherein said guide means are pulleys.

4. The moving display system of claim 1 wherein:
a. a rotational motion device is connected to one of said guide means forming
a drive pulley.
b. said drive pulley has a sufficient frictional coefficient on its surface adjoining said loop to impart motion to said loop.

5. The moving display system of claim 4 wherein said rotational motion device is an electrically driven motor,

6. The moving display system of claim 1 wherein:
a. said displayed object is the form of a ghost,
b. said ghost comprises a covering,
c. said covering wrapped around filler material to form a head,
d. a restricting means to secure said covering about said filler material.

7. The moving display system of claim 1 wherein:
a. said connecting means comprises a length of connecting line,
b. means to attach said connecting line to said loop,
c. means to attach said connecting line to said displayed object.

8. The moving display system of claim 7 wherein said connecting line is the same material as used in said loop.

9. The moving display system of claim 7 wherein a rotational means is provided to allow said connecting line to rotate about its axis.

10. The moving display system of claim 9 wherein said rotational means is a swivel.

11. The moving display system of claim 1 wherein:
a. said supporting means includes a pulley screw,
b. said pulley screw provides the axis for the pulley rotation,
c. said pulley screw attaches to a fixed object,
d. said pulley screw is orientated such that said loop and said connecting means pass freely around said pulley.
